(19) United States
(12) Patent Application Publication
(10) Pub. No.: US 2008/0104008 A1
(43) Pub. Date: May 1, 2008

(54) COMMON DATA BROKER METHOD, SYSTEM, AND PROGRAM PRODUCT

(76) Inventors: David L. Brantley, Kennesaw, GA (US); Choulin Woo, Duluth, GA (US)

Correspondence Address: HOFFMAN, WARNICK & D'ALESSANDRO LLC, 75 STATE ST, 14TH FLOOR, ALBANY, NY, 12207, US

(21) Appl. No.: 11/554,711

(22) Filed: Oct. 31, 2006

(51) Int. Cl. G06F 17/30

(52) U.S. Cl. 707/1

(57) ABSTRACT

The present invention provides a common data entity broker method, system, and program product. Specifically, under the present invention, a common data broker is provided that includes an administrative module, a common data broker interface, a common data key mapping, and a common data database. In general, common data entities are stored in the common data database according to their assigned common data entity type and common data entity key. The common data mapping contains an association of each common data entity to its common data entity type and common data entity key. The mapping also associates common data entity types and common data entity keys with external key and external data entity types that are used by external systems/systems requesting a common data entity.

### BACKGROUND OF THE INVENTION

1. Field of the Invention

The present invention generally relates to data brokering. Specifically, the present invention provides a common data broker method, system, and program products.

2. Related Art

A common challenge to integrate enterprise systems is to find an effective way to manage common data and share data. Very often these systems will have some data overlap. Quite often the integration is done by duplicating the data across the individual systems 10A-C as shown in FIG. 1. A common way of sharing data as shown involves implementing an enterprise data model 12 using a centralized master database (not shown). This approach can be very time consuming and can introduce much complexity. Moreover, this integration often requires interfaces to be built in order to exchange data and perform data model transformation. It is especially true since many enterprises already have many existing mission critical applications, and the existing applications have their own databases with common data often being duplicated

As such, the most common way to integrate these existing systems is to build an interface 14A-B among systems 10A-C as shown in FIG. 2. Each system 14A-B passes the shared data to each other. The shared data needs to be processed by the receiving systems and integrated it into its own database. Thus, duplication of the shared data will be necessary for it to be visible in the target systems. It is often expensive and complicated to build this interface. The interface can also be complicated, especially when the two systems have very distinct and different data models. To keep the shared data synchronized between the two systems can be complex and difficult to accomplish.

In view of the foregoing, there exists a need for an approach that solves at least one of the deficiencies of the related art.

### SUMMARY OF THE INVENTION

In general, the present invention provides a common data entity broker method, system, and program product. Specifically, under the present invention, a common data broker is provided that includes an administrative module, a common data broker interface, a common data key mapping, and a common data database. In general, common data entities are stored in the common data database according to their assigned common data entity type and common data entity key. The common data mapping contains an association of each common data entity to its common data entity type and common data entity key. The mapping also associates common data entity types and common data entity keys with external key and external data entity types that are used by external system(s) requesting a common data entity.

In a typical embodiment, a request for a common data entity is received from an external system by the common data broker interface. The external request is typically accompanied by an external key, an external data entity type, and a system identifier associated with an external system. The common data broker interface will then identify the common data entity key and a common data entity type from the common data key mapping based on the external key, the external data entity type, and the system identifier. Thereafter, the common data broker interface will obtain the common data entity from the common data database using the common data entity type and the common data entity key, and send the common data entity to the external system.

A first aspect of the present invention provides a common data broker method, comprising: associating an external key and a common data entity key corresponding to a common data entity in a common data key mapping; receiving an external request for the common data entity, the request being accompanied by the external key; identifying the common data entity key from the common data key mapping using the external key; and obtaining the common data entity from a common data database using the common data entity key.

A second aspect of the present invention provides a common data broker system, comprising: a common data broker interface for receiving a request for a common data entity from an external system, the request being accompanied by an external key, an external data entity type and a system identifier associated with the external system; a common data key mapping for associating the external key, the external data entity type, and the system identifier with a common data entity type, and a common data entity key; and a common data database containing the common data entity as associated with the common data entity key and the common data entity type.

A third aspect of the present invention provides a program product stored on a computer readable medium for brokering common data between distinct systems, the computer readable medium comprising program code for causing a computer system to perform the following: associate an external key and a common data entity key corresponding to a common data entity in a common data key mapping; receive an external request for the common data entity, the request being accompanied by the external key; identify the common data entity key from the common data key mapping using the external key; and obtain the common data entity from a common data database using the common data entity key.

A fourth aspect of the present invention provides a method for deploying a system for brokering common data between distinct systems, comprising: providing a computer infrastructure being operable to: associate an external key and a common data entity key corresponding to a common data entity in a common data key mapping; receive an external request for the common data entity, the request being accompanied by the external key; identify the common data entity key from the common data key mapping using the external key; and obtain the common data entity from a common data database using the common data entity key.

A fifth aspect of the present invention provides computer software embodied in a propagate signal for brokering common data between distinct systems, the computer software comprising instructions for causing a computer system to perform the following: associate an external key and a common data entity key corresponding to a common data entity in a common data key mapping; receive an external request for the common data entity, the request being accompanied by the external key; identify the common data entity key from the common data key mapping using the external key; and obtain the common data entity from a common data database using the common data entity key.

A sixth aspect of the present invention provides a data processing system for brokering common data between distinct systems, comprising: a processor; a bus coupled to the processor; a memory medium comprising program code for causing the processor to: associate an external key and a common data entity key corresponding to a common data entity in a common data key mapping; receive an external request for the common data entity, the request being accompanied by the external key; identify the common data entity key from the common data key mapping using the external key; and obtain the common data entity from a common data database using the common data entity key.

### BRIEF DESCRIPTION OF THE DRAWINGS

The foregoing and other exemplary purposes, aspects and advantages will be better understood from the following detailed description of an exemplary embodiment of the invention with reference to the drawings.

FIG. 1 depicts an approach for sharing data among enterprise systems according to the prior art.

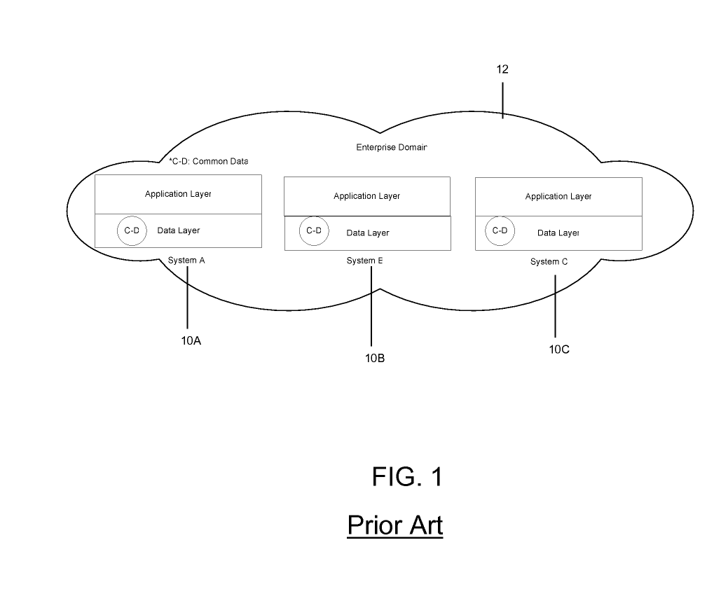

FIG. 2 depicts interfaces for sharing data among the enterprise systems of FIG. 1 according to the prior art.

FIG. 3 depicts a common data entity system according to the present invention.

FIG. 4 depicts the common data broker of FIG. 3 in greater detail according to the present invention.

FIG. 5 depicts an illustrative common data entity retrieval operation according to the present invention.

FIG. 6 depicts an illustrative common entity data brokering example among multiple distinct enterprise systems according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience the Detailed Description of the Invention has the following Sections:

I. General Description

II. Illustrative Embodiment

### I. General Description

As indicated above, the present invention provides a common data entity broker method, system, and program product. Specifically, under the present invention, a common data broker is provided that includes an administrative module, a common data broker interface, a common data key mapping, and a common data database. In general, common data entities are stored in the common data database according to their assigned common data entity type and common data entity key. The common data mapping contains an association of each common data entity to its common data entity type and common data entity key. The mapping also associates common data entity types and common data entity keys with external key and external data entity types that are used by external system(s) requesting a common data entity.

In a typically embodiment, a request for a common data entity is received from an external system by the common data broker interface. The external request is typically accompanied by an external key, an external data entity type, and a system identifier associated with an external system. The common data broker interface will then identify the common data entity key and a common data entity type from the common data key mapping based on the external key, the external data entity type, and the system identifier. Thereafter, the common data broker interface will obtain the common data entity from the common data database using the common data entity type and the common data entity key, and send the common data entity to the external system.

### II. Illustrative Embodiment

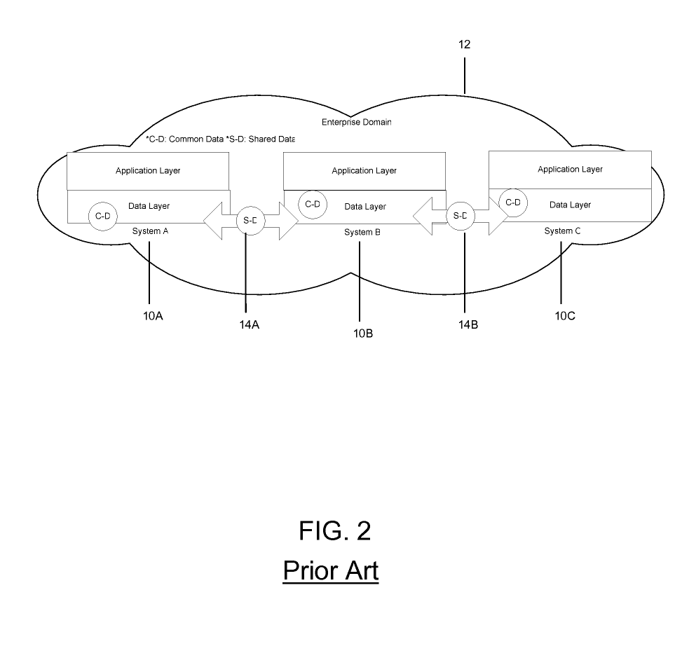

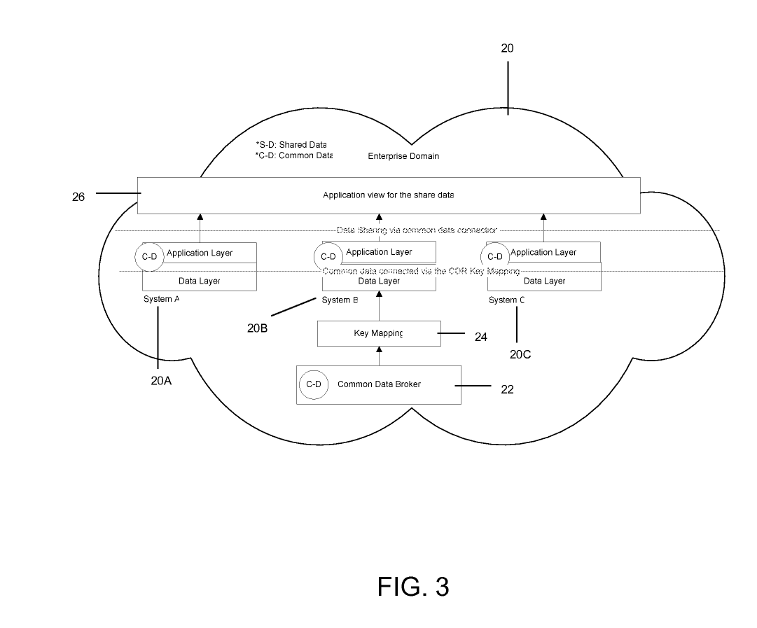

Referring now to FIG. 3, an illustrative embodiment of the present invention is shown. Specifically, the embodiment shown in FIG. 3 depicts an enterprise domain 18 having distinct systems 20A-C, and an application view 26. FIG. 3 also depicts a Common Data Broker (CDB) 22 that provides an effective way to share data among systems 20A-C via a common set of data (shown as C-D). In general, CDB 22 provides an alternative to data duplicating interfaces such as those shown in FIG. 2. Using the CDB 22, data in different applications can be shared without building interfaces between the applications and/or duplicating data in each application. CDB 22 provides an alternative for applications to share data via the common data set. Specifically, CDB 22 provides the binding between the common data set of each system 20A-C. A common interface is provided by CDB 22 to allow access from various systems. The common data will be consistently managed by CDB 22 so business rules can be consistently implemented. In short, some of the objectives for CDB 22 include: (1) providing a common interface to maintain common data; (2) providing binding between the common data set of each system so each system knows how its own common data set is related to the other systems. The common data set can be used later to share data between systems; (3) providing consistent way to access the common data from different systems; and (4) removing the need of duplicating data in order to share data cross different systems.

In any event, as further shown in FIG. 3, the present invention provides a key mapping 24. Among other things (and as will be further explained below), key mapping 24 associates an external key corresponding to a common data entity with a common data entity key also corresponding to the common data element. Thus, when a system 20A requests a common data entity, it communicates its external key (and other optional information such as a system identifier and an external common data entity type) along with the request. The external key (and other information) is used to identify an associated common data entity key and a common entity data type from key mapping 24. The common data entity key and common entity data type is then used to obtain the requested common data entity from a common entity database or the like.

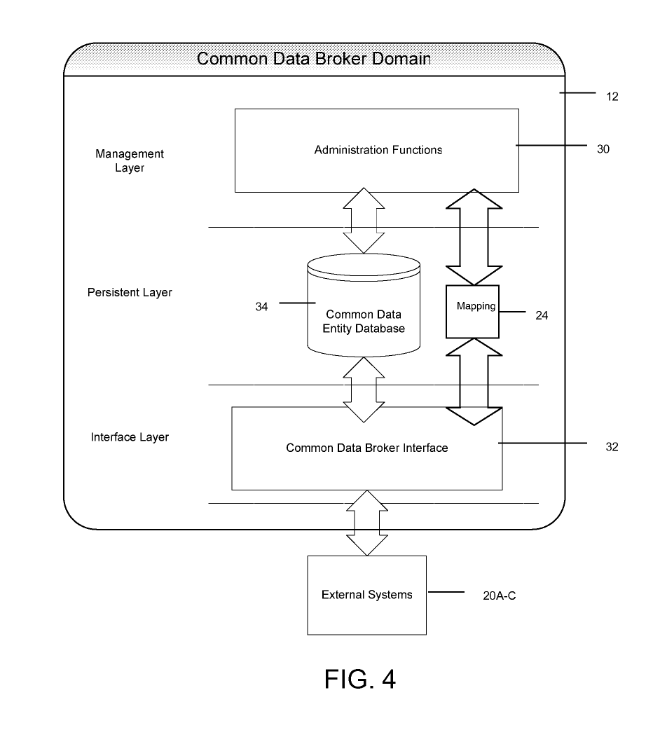

Referring now to FIG. 4, a more detailed diagram of CDB 22 is shown. As depicted CDB 22 includes a persistent layer for storage of common data in common data entity database 34, an interface layer including a common data broker interface 32 to allow data access from external systems 20A-C, and a management layer which provides administrative and data cleansing functionality. The functionality of each of these layers includes as follows:

### Persistent Layer

A. Common Data Entity Database

The main objective for common data entity database 34 is to persist the data. Common data entity database 34 can contain one or many common data entities. The common data entity database 34 could be a single database or distributed to more than one database.

B. Common Data Entity

Common Data Entity (CDE) is the logical definition of the data entities. A data entity can have one or many data fields, which define the common data entities that can be shared by different systems. To define a data entity, here are the some best practices:
Persist each CDE type in its own space. For example, if a DB2 database is used as the persistent device, each CDE type should be stored in a single data table. This will provide flexibility to spread the data entities across different databases.
For defining a CDE, the main objective is to define the very core of the common data set so want to keep the number of CDE data fields as small as possible.
For each CDE type, the combination of values across all the data fields should be unique.
To keep the definition of a CDE simple, the definition should avoid referencing other CDE type.
Each CDE instance shall have a primary key defined. The primary key is generated and maintained by the CDB. Each data field of a CDE can be used as search criteria by the external system via the interface.
For de-duping, all the data fields of a CDE should be used.
In addition to the data fields and primary key for a CDE, there is a set of common system fields, such as version number, last update timestamp etc, which should be included in all CDE definitions. The system fields are used by the CDB for the CDB interface and system management functions.

### Interface Layer

A. Common Data Broker Interface (CDBI)

CDBI 32 is meant to provide access to the common data from the external systems. The main functions of the CDBI 32 are authority control, search, create, update, delete, associate, disassociate, and lock control and version control. The CDBI 32 could be a synchronous or an asynchronous interface. The external systems 20A-C can be divided into 3 different categories:
Owner System
Trusted System
Guest System

The authority of each type of system 20A-C should be configurable. The best practice typically suggests that the Owner System will have all authority. Trusted systems will have all the same authority as the Owner systems except the delete authority. Guest systems should have only the search, associate and disassociate authority.

B. Interface Functions

Following are the key functions that the interface supports: Access Control, Lock Control, Version Control, Key Management, Search, Create, Update, Delete, Association and Disassociation. The CDBI will ensure the external system has proper authority to execute any of the interface functions. The authority of the external system is defined when the external system is registered with the CDB.

1. Access Control

Before the external system can access the CDB, the interface needs to determine what kind of function is allowed for the external system based on the system categories. There are 3 different system categories: Owner, Trusted or Guest. For each CDE type, the external systems can belong to only one of the categories. For each Common Data Entity, there could be more than one system in each of the categories.

2. Lock Control

Because there could be more than one owner and trusted systems for each CDE, there could be collision when more than one owner or trusted systems attempts to change the same Common Data Entity. The lock control allows the system to hold a lock of a Common Data Entity for period of time. It is the responsibility of the system, which held the lock, to release the lock. A predefine time can be set so the lock can be released automatically when the time expired, or the lock can be released through administrative functions.

3. Version Control

Version control is used to ensure the data update is based on the most current contents. If the external system chooses to keep a local read-only replica of the common data, the version can be used to determine if the local copy is out-of-date. In order to apply the updates, the version control can ensure the external system has the latest contents before the updates.

4. Common Data Entity Key (CDEK) Management

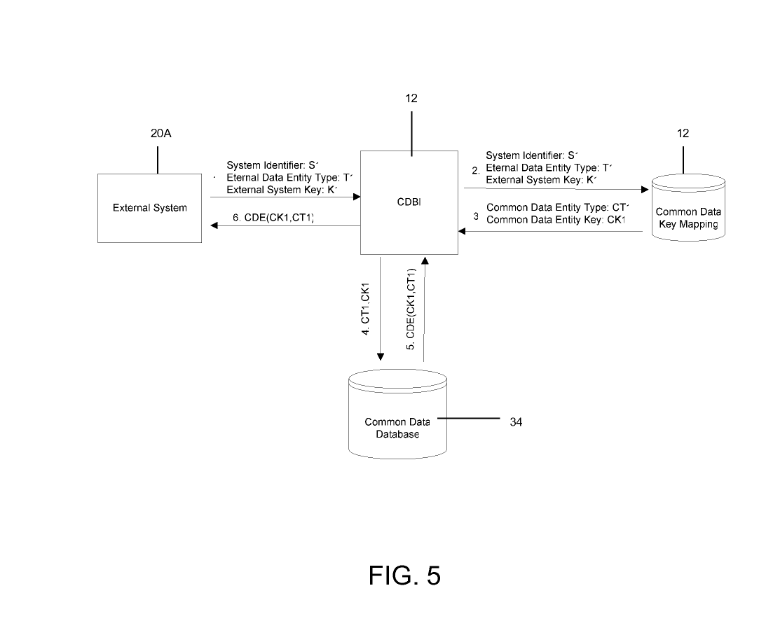

Each data entity contains a primary key, which is generated and assigned by the CDB 22 interface call. The Common Data Entity Key (CDEK) could be used as the common data token to allow systems to share their data easily. The CDEK is mapped to an external system key provided by the external system. The key mapping function provided by the CDB 22 provides a convenient way for the external system to access the CDB22. When the external system accesses the CDB 22, it can use its own key without knowing how it maps to the CDEK. The CDBI 32 converts the external system key to the CDEK before accessing the data (FIG. 5).

Referring now to FIG. 5, an illustrative example is shown. Specifically, in FIG. 5 the external system 20A queries the common data database 34 by providing its own system identifier (S1), the data entity type (T1) and source key (K1) to CDBI 32. After validating the external system's authority, CDBI 32 queries key mapping 24 (shown in a common data key mapping database) to translate the data entity type and source key to CDB data type (CT1) and key (CK1). CDBI 32 then uses the CDB data type and key to query the common data database 34, which returns the CDE with the requested CDB data type and key. CDBI 32 then sends the CDE to external system 20A.

For each CDE, a CDEK can map to one or many external system keys. Each external system key and source type combination can only map to one CDEK. The CDEK management function alleviates the need for each of the external systems to keep up with how the key is mapped. Once the common data in each of the external system can be related to each other via the CDEK mapping, the data in each of the external system can be visible to each other. The key mapping generally contains the following main fields:
External System Identifier
External Data Entity Type
External Key
CDE Type
CDE Key

The CDBI 32 call returns the CDE Type and CDE key in addition to the CDE data requested. The best practice is for the external system 20A to use the CDBI 32 to get the common CDE key. It can use the CDBK as common token by joining the CDBI's key mapping data. The data in each system can be shared once they can be related via the CDBK.

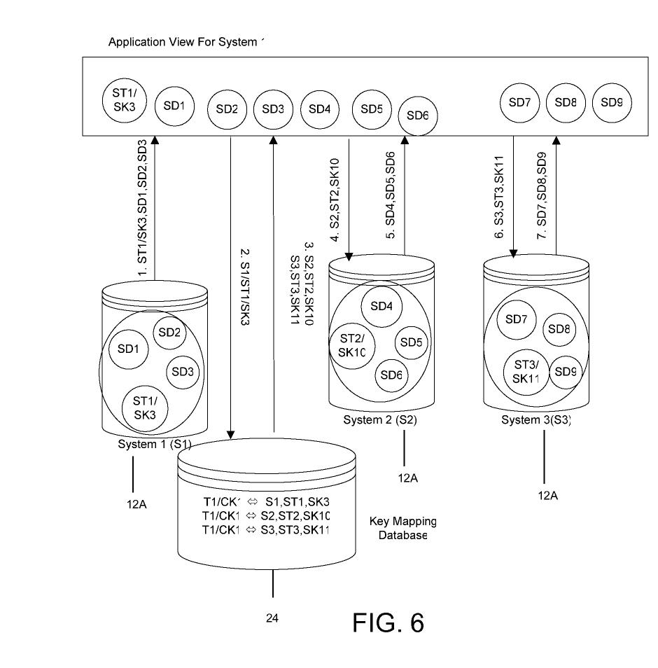

Referring now to FIG. 6, is an example of sharing data using the CDB 22 (FIG. 3). System 20A registers its common data with the common data database. In addition to the data in its own database, it also needs the data from system 20B and system 20C that are related to the same common data. So after the application selects common data ST1/SK1 and read in the data related to ST1/SK1, which are SD1, SD2 and SD3. It queries the CDB 22 to find the related common data that is related to ST1/SK1 in system 2 and system 3. It returns ST2/SK10 for system 20C and ST3/SK11 for system 20B. The application then queries the system 20B to find the data that is related to ST2/SK10, which return SD4, SD5 and SD6. It also queries the system 20C to find the data that is related to ST3/SK11 which return SD7, SD8 and SD9.

In general, the following additional functionality is provided at the interface layer.

5. Search

### There are different ways that the external system can search the CDB:

Search by External Data Entity Type and External Data Entity Key. External Data Type and Key will be translated to the CDE type and key by the interface before accessing the data. One row should be returned as the result of the search.
Search by any of the Common Data fields. Fuzzy search will be allowed when doing this kind of search. One or many rows may return as result of the search.
Search can also be done by using CDE type and CDE key when the application stores a local copy of the CDE key. However, this method is not considered best practice because it will require the application to ensure the key mapping is up to date with the CDB. One row should be returned as the result of the search.
   Data search function will not require data lock before returning the results. Search is allowed for all external system types.

6. Create

The External Data Type and Key along with the common data field values shall be populated when issuing the Create function. The corresponding Common Data Entity Type and Key will be returned. There are two possible outcomes as result of the create request:
1. A new row is created in the CDB along with a new CDEK. A new key-mapping row will also be created so the External Data Entity Type and Key will be mapped to the newly created Common Data Entity Type and Key.
2. An existing row is found in the CDB with the exact same common data field values. A new key-mapping row will be created so the External Data Entity Type and Key will be mapped to the existing CDB Type and Key.

### The CDE Type and Key will be returned as the result of the create function.

7. Update

The update function will require a data lock prior applying the data updates. The data version will also be checked to ensure the external system has the current version of the data prior to the update. Based on the definition of the external system, the external system can either change the contents of the common data entity or disassociate itself with the current common data entity because of the content change. If the disassociation happens, the CDB will either associate the newly updated data entity with another existing data entity or create a new data entity.

8. Delete

A data lock is required prior to the actual deletion. As part of the deletion function, the corresponding key mapping data will also be deleted. If there are other Owner systems for the data entity, the interface could choose to simply remove the key mapping entry but not the data entity. This will be an implementation design decision. The deleted data entity and key mapping data could optionally be archived for future reference.

9. Association

The association function is basically to create a new key-mapping row so a new source entity can be mapped to an existing common data entity. The association function can be logically based on the results of a search function. After the search, the external system could decide to tie a new source data entity to an existing common data entity by adding a new mapping row in the key mapping data table.

10. Disassociation

The Disassociation function is to remove the mapping between an existing source data entity and the common data entity. After the Disassociation is completed, the external systems could decide to either create a brand new common data entity along with the new key mapping, or associate the source entity to a different common data entity.

11. Get Key Mapping Data

This function is to provide external key data that are mapped to the one provided by any of the external system. The external system, which calls this function, should already register and provide data to the CDB. The external system provides its own key for the particular CDE it is interested in. The function will return all or any of the other external system keys, which map to the same CDE. The external system could then use the returned key data to query other external system.

### Management Layer

A. Administrative Functions

The following administrative functions will be provided by the Common Data Broker system.
De-duping
De-duping is to find data duplication for a given common data entity in a batch fashion. It will perform fuzzy matches using the data contents in the data fields of a common data entity. The results of the matching will be present to the users who have in-depth knowledge about the data and be able to detect duplicates. Once duplicates are found, the user will use the merge function to remove the duplicates.
Merge function
Merge is to remove the duplicated data in the common data database. As a result of the merges, the duplicated common data entities will be deleted from the database. The key mapping data will also be updated so the common data entity key will contain the key of the merge winner. A new row will also be created in a table for merge history. The new row will show the loser key map to the winner key. The loser to winner key mapping can be used later for situations such as the external system using the loser CDE key to query the CDB.
Maintain subscription list
A pub/sub interface can be implemented so that if there are changes to the common data, the external system, which is interested in the data, can be notified.
Force Lock
Force Lock function is to manually lock one or many common data entities so no other systems can work on the data. The Force Lock can be external system specific, data entity type specific or row specific. For example, we can issue a force lock on all the data provided by particular external system systems in order to perform system maintenance.
Force unlock
Force Unlock is to manually unlock one or many common data entities. The Force Unlock can be external system specific, data entity type specific or row specific. For example, we can issue a force unlock for a common data entity when the current lock holder failed to unlock the record due to system failure.
System Registration Maintenance
This function is to register and de-register the external systems, which can access the common data Broker. When an external system is registered, the system type and authority levels are defined. When an external system is de-registered, the data entities and key mapping data from the system will be deleted from CDB and archived.
Data Entity Type Registration Maintenance
This function is used when a new data entity type is added to the common data Broker. As part of the registration, it defines the owner, trusted and guest systems for the data entity. When a data entity type is de-registered, the data and the key mapping will be removed from CDB and archived. The maintenance function should also include the feature to define the update behavior to the data entity type for each of the registered systems.
Archive
The archive function is to move the data that is longer in use by CDB to a data storage that is not used by the CDB. The data in archive can be used for historical and audit purpose.
Reporting
Produce reports for administrative and monitoring purposes.

B. Migration

Migration program will be used to assist the system, which wants to interface with the common data Broker. The external data entity type and key will be defined and mapped to common data entity and key prior to the migration. The migration will create the common data and key mapping data in a batch fashion.

The Common Data Broker therefore provides a common and consistent interface to maintain the common data set for the enterprise. It also provides the information on how to share the data in different enterprise systems via the common data set. The design allows the systems to share the data without knowing how the individual data models relate. The responsibility of maintaining the common data is spread across different systems. The common data is consistently mapped and controlled in one central place so different systems can be bound using the common data set. CDB allows data sharing without building complex interfaces, transforming data models and duplicating data in different systems. The same design and concept is flexible enough to allow it to be extended for sharing across different enterprises.

While shown and described herein as common data brokering solution, it is understood that the invention further provides various alternative embodiments. For example, in one embodiment, the invention provides a computer-readable/useable medium that includes computer program code to enable a computer infrastructure to broker common data. To this extent, the computer-readable/useable medium includes program code that implements each of the various process of the invention. It is understood that the terms computer-readable medium or computer useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a device (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to broker common data. In this case, the service provider can create, maintain, deploy, support, etc., a computer infrastructure that performs the process of the invention for one or more customers. In return, the service provider can receive payment from the target organization(s) under a subscription and/or fee agreement and/or the service provider can receive payment from the sale of advertising content to one or more third parties.

In still another embodiment, the invention provides a computer-implemented method for mapping widgets. In this case, a computer infrastructure can be provided and one or more systems for performing the process of the invention can be obtained (e.g., created, purchased, used, modified, etc.) and deployed to the computer infrastructure. To this extent, the deployment of a system can comprise one or more of (1) installing program code on a device such as controlling and/or controlled computers, from a computer-readable medium; (2) adding one or more devices to the computer infrastructure; and (3) incorporating and/or modifying one or more existing systems of the computer infrastructure to enable the computer infrastructure to perform processes according to one or more aspects of the invention.

As used herein, it is understood that the terms “program code” and “computer program code” are synonymous and mean any expression, in any language, code or notation, of a set of instructions intended to cause a device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular providing and/or I/O device, and the like.

Aspects of the invention can take the form of an entirely software embodiment or an embodiment containing both hardware and software elements. In an embodiment, aspects of the invention are implemented in software, which includes but is not limited to firmware, resident software, microcode, etc. Furthermore, aspects of the invention can take the form of a computer program product accessible from at least one computer-usable or computer-readable medium storing program code for use by or in connection with a computer or any instruction execution system. For the purposes of this description, a computer-usable or computer readable medium can be any tangible apparatus that can contain, store, communicate, propagate, and/or transport the program for use by or in connection with the instruction execution system, apparatus, device, and/or the like.

The medium can be an electronic, magnetic, optical, electromagnetic, infrared, or semiconductor system (or apparatus or device), a propagation medium, and/or the like. Examples of a computer-readable medium include, but are not limited to, a semiconductor or solid-state memory, magnetic tape, a removable computer diskette, a random access memory (RAM), a read-only memory (ROM), a rigid magnetic disk and an optical disk. Current examples of optical disks include, but are not limited to, compact disk—read only memory (CD-ROM), compact disk—read/write (CD-R/W) and DVD.

A data processing system suitable for storing and/or executing program code can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A common data broker method, comprising:
associating an external key and a common data entity key corresponding to a common data entity in a common data key mapping;
receiving an external request for the common data entity, the request being accompanied by the external key;
identifying the common data entity key from the common data key mapping using the external key; and
obtaining the common data entity from a common data database using the common data entity key.

2. The common data broker method of claim 1, the external request being received in a common data broker interface.

3. The common data broker method of claim 2, the external request being further accompanied by an external data entity type and a system identifier associated with an external system from which the external request was received.

4. The common data broker method of claim 3, the identifying comprising the common data broker interface identifying the common data entity key and a common data entity type from the common data key mapping based on the external key, the external data entity type, and the system identifier.

5. The common data broker method of claim 4, the obtaining comprising the common data broker interface obtaining the common data entity from the common data database using the common data entity type and the common data entity key.

6. The common data broker method of claim 5, further comprising sending the common data entity to the external system from the common data interface broker.

7. A common data broker system, comprising:
a common data broker interface for receiving a request for a common data entity from an external system, the request being accompanied by an external key, an external data entity type and a system identifier associated with the external system;
a common data key mapping for associating the external key, the external data entity type, and the system identifier with a common data entity type, and a common data entity key; and
a common data database containing the common data entity as associated with the common data entity key and the common data entity type.

8. The common data broker system of claim 7, the common data broker interface further obtaining the common data entity type and the common data entity key from the common data key mapping using the system identifier, the external data entity type, and the external key.

9. The common data broker system of claim 8, the common data broker interface further obtaining the common data entity from the common data database using the common data entity type and the common data entity key.

10. The system of claim 9, the common data broker interface further sending the common data entity to the external system.

11. A program product stored on a computer readable medium for brokering common data between distinct systems, the computer readable medium comprising program code for causing a computer system to perform the following:
associate an external key and a common data entity key corresponding to a common data entity in a common data key mapping;
receive an external request for the common data entity, the request being accompanied by the external key;
identify the common data entity key from the common data key mapping using the external key; and
obtain the common data entity from a common data database using the common data entity key.

12. The common data broker method of claim 11, the external request being further accompanied by an external data entity type and a system identifier associated with an external system from which the external request was received.

13. The common data broker method of claim 12, the computer readable medium further comprising program code for causing the computer system to perform the following: identifying the common data entity key and a common data entity type from the common data key mapping based on the external key, the external data entity type, and the system identifier.

14. The common data broker method of claim 13, the computer readable medium further comprising program code for causing the computer system to perform the following:
obtaining the common data entity from the common data database using the common data entity type and the common data entity key.

15. The common data broker method of claim 14, the computer readable medium further comprising program code for causing the computer system to perform the following:
sending the common data entity to the external system from the common data interface broker.
